(19) United States
(12) Patent Application Publication
(10) Pub. No.: US 2026/0313564 A1
(43) Pub. Date: Oct. 8, 2026

(54) METHOD AND APPARATUS FOR FREQUENCY-SELECTIVE TRANSMIT POWER CONTROL IN A WIRELESS COMMUNICATION SYSTEM

(71) Applicant: SAMSUNG ELECTRONICS CO., LTD., Suwon-si, Gyeonggi-do (KR)

(72) Inventors: Alexei Vladimirovich DAVYDOV, Moscow (RU); Gregory Vladimirovich MOROZOV, Moscow (RU); Dmitry Sergeyevich DIKAREV, Moscow (RU); Gregory Aleksandrovich ERMOLAEV, Moscow (RU); Denis Viktorovich ESIUNIN, Nizhny Novgorod (RU); Maksim Viktorovich ESIUNIN, Nizhny Novgorod (RU); Vladimir Alexandrovich PESTRETSOV, Moscow (RU)

(21) Appl. No.: 19/490,277

(22) PCT Filed: May 9, 2024
(86) PCT No.: PCT/KR2024/006299

§ 371 Date: Dec. 4, 2025

(30) Foreign Application Priority Data
Jul. 19, 2023 (RU) 2023119092

(51) Int. Cl. H04W 52/36; H04W 72/231; H04W 76/20

(52) U.S. Cl. CPC H04W 52/367; H04W 72/231; H04W 76/20

(57) ABSTRACT

The disclosure relates to a 5G or 6G communication system for supporting a higher data transmission rate. The present invention relates to the field of communications. The proposed method of frequency-selective control of a power of an uplink channel transmission includes dividing an available frequency band into a plurality of sub-bands to be used in the frequency-selective power control of UL transmissions, determining transmit power adjustment values for each sub-band obtained by dividing, and signalizing the determined sub-bands obtained by dividing and the corresponding transmit power adjustment values for these sub-bands for their subsequent application, which, as a result, provides at least the reduction in inter-cell interference and the performance gain of the user terminals located close to cell edges.

### TECHNICAL FIELD

The present disclosure relates to the field of communications, namely to methods and devices for frequency-selective transmit power control for sixth generation (6G) communication systems with support for Multi-User (MU) mode and antenna systems with spatial signal coding (MIMO).

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to frequency-selective transmit power control.

### Solution to Problem

Due to the present invention, the above and other problems, although not explicitly stated, but associated with the above-listed problems in the prior art, or arising from them, are solved or at least mitigation of severity of these problems is achieved. The above and additional problems/tasks and corresponding beneficial technical effects achieved will be further discussed in the following description in the context of specific features of the technical solution proposed in this application.

In a first aspect of the present invention, there is provided a Transmission-Reception Point (TRP)-implementable method of frequency-selective control of a power of an Uplink (UL) channel transmission by User Equipment (UE), the method comprising the steps of: dividing an available frequency band into a plurality of sub-bands to be used by the UE when transmitting the UL channel to the TRP with frequency-selective transmit power control; setting, for each sub-band of said plurality of sub-bands, the transmit power adjustment value to be used by the UE to adjust the power in the corresponding sub-band when transmitting the UL channel to the TRP; transmitting an indication of said plurality of sub-bands to the UE, wherein, for each sub-band, the indication additionally signalizes the transmit power adjustment value corresponding to that sub-band; and waiting to receive or receiving from the UE the UL channel transmission with a frequency-selective power adjustment carried out on the basis of the transmitted indication.

In a possible implementation of the method according to the first aspect of the present invention, said indication is a Transmit Power Control (TPC) command in a Downlink Control Information (DCI) message or a Radio Resource Control (RRC) procedure configuration message.

In a possible implementation of the method according to the first aspect of the present invention, the UL channel is a Physical Uplink Shared Channel (PUSCH).

In a possible implementation of the method according to the first aspect of the present invention, the dividing of the available frequency band into the plurality of sub-bands and the setting of the corresponding transmit power adjustment values are carried out by performing an RRC procedure between the TRP and the UE.

In a possible implementation of the method according to the first aspect of the present invention, the dividing of the available frequency band is performed into the plurality of sub-bands of a same width or into the plurality of sub-bands of different width, wherein the width of the sub-bands is set by a number of Resource Elements (REs) or a number of Resource Blocks (RBs) so that the sub-band includes one or more REs or one or more RBs.

In a possible implementation of the method according to the first aspect of the present invention, the dividing of the available frequency band into the plurality of sub-bands includes forming a combined sub-band by combining two or more adjacent sub-bands of a same width in case if the same transmit power adjustment value is set for these two or more adjacent sub-bands, wherein a start and an end of the combined sub-band is being indicated by: an index of the first RE or RB of the combined sub-band and an index of the last RE or RB of the combined sub-band; or an index of the first RE or RB of the combined sub-band and a number of REs or RBs in the combined sub-band; or an index of the first RE or RB of the combined sub-band and an index of the first RE or RB of the sub-band following after said combined sub-band.

In a possible implementation of the method according to the first aspect of the present invention, the setting, for a sub-band of said plurality of sub-bands, of the transmit power adjustment value is performed depending on a number of UEs transmitting simultaneously within this sub-band.

In a possible implementation of the method according to the first aspect of the present invention, a range of possible power adjustment values is dynamically expanded by using, in the DCI message or the RRC configuration message, additional TPC command bit values indicating additional transmit power adjustment (tuning) values.

In a possible implementation of the method according to the first aspect of the present invention, the transmit power adjustment value in each sub-band is set relative to a reference transmit power level common to all the sub-bands or relative to a transmit power level in the previous sub-band.

In a possible implementation of the method according to the first aspect of the present invention, the Transmission-Reception Point (TRP) is a Base Station (BS), an Access Point (AP), or a Node B (NodeB).

In a possible implementation of the method according to the first aspect of the present invention, the frequency-selective power adjustment carried out on the basis of the transmitted indication modifies a Power Spectral Density (PSD).

In a second aspect of the present invention, there is provided a Transmission-Reception Point (TRP) comprising a transmitting-receiving antenna unit and a processor, the processor configured to perform the method according to the first aspect of the present invention or according to any possible implementation of the first aspect of the present invention.

In a third aspect of the present invention, there is provided a storage medium storing processor-executable instructions which, when executed by a processor of a device equipped with a transmitting-receiving antenna unit, allow for performing the method according to the first aspect of the present invention or according to any possible implementation of the first aspect of the present invention.

In a fourth aspect of the present invention, there is provided User Equipment (UE)-implementable method of frequency-selective control of a power of an Uplink (UL) channel transmission to a Transmission-Reception Point (TRP), the method comprising the steps of: receiving, from a TRP, an indication of a plurality of sub-bands obtained by dividing an available frequency band and to be used by the UE when transmitting the UL channel to the TRP with frequency-selective transmit power control, wherein, for each sub-band, said indication additionally signalizes the transmit power adjustment value set for the sub-band and to be used by the UE for adjusting the power in this sub-band when transmitting the UL channel to the TRP; and transmitting the UL channel to the TRP while performing a frequency-selective power adjustment carried out on the basis of the received indication.

In a possible implementation of the method according to the fourth aspect of the present invention, said indication is a Transmit Power Control (TPC) command in a Downlink Control Information (DCI) message or a Radio Resource Control (RRC) procedure configuration message.

In a possible implementation of the method according to the fourth aspect of the present invention, the UL channel is a Physical Uplink Shared Channel (PUSCH).

In a possible implementation of the method according to the fourth aspect of the present invention, the plurality of sub-bands and the corresponding plurality of transmit power adjustment values are configured by performing an RRC procedure between the TRP and the UE.

In a possible implementation of the method according to the fourth aspect of the present invention, the plurality of sub-bands includes sub-bands of a same width and/or sub-bands of different width, wherein the width of the sub-bands is set in the indication by a number of Resource Elements (REs) or a number of Resource Blocks (RBs) so that the sub-band includes one or more REs or one or more RBs.

In a possible implementation of the method according to the fourth aspect of the present invention, the plurality of sub-bands includes a combined sub-band, wherein a start and an end of the combined sub-band is being indicated in the indication by: an index of the first RE or RB of the combined sub-band and an index of the last RE or RB of the combined sub-band; or an index of the first RE or RB of the combined sub-band and a number of REs or RBs in the combined sub-band; or an index of the first RE or RB of the combined sub-band and an index of the first RE or RB of the sub-band following after said combined sub-band.

In a possible implementation of the method according to the fourth aspect of the present invention, for a sub-band of said plurality of sub-bands, the transmit power adjustment value indicated in said indication is set depending on a number of other UEs transmitting simultaneously with said UE within this sub-band.

In a possible implementation of the method according to the fourth aspect of the present invention, a range of possible power adjustment values is dynamically expanded by using, in the DCI message or the RRC configuration message, additional TPC command bit values indicating additional transmit power adjustment values.

In a possible implementation of the method according to the fourth aspect of the present invention, the transmit power adjustment value in each sub-band is set relative to a reference transmit power level common to all the sub-bands or relative to a transmit power level in the previous sub-band.

In a possible implementation of the method according to the fourth aspect of the present invention, the frequency-selective power adjustment carried out on the basis of the received indication modifies a Power Spectral Density (PSD).

In a fifth aspect of the present invention, there is provided User Equipment (UE) comprising a transmitting-receiving antenna unit and a processor, the processor configured to perform the method according to the fourth aspect of the present invention or according to any possible implementation of the fourth aspect of the present invention.

In a sixth aspect of the present invention, there is provided a storage medium storing processor-executable instructions which, when executed by a processor of a device equipped with a transmitting-receiving antenna unit, allow for performing the method according to the fourth aspect of the present invention or according to any possible implementation of the fourth aspect of the present invention.

In a seventh aspect of the present invention, there is provided a communication system comprising one or more Transmission-Reception Points (TRPs) according to the second aspect of the present invention or according to any possible implementation of the second aspect of the present invention, and the one User Equipment (UE) or more UEs according to the fifth aspect of the present invention or according to any possible implementation of the fifth aspect of the present invention.

### Advantageous Effects of Invention

Aspects of the present disclosure provide efficient communication methods in a wireless communication system.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1 illustrates a flowchart of a Transmission-Reception Point (TRP)-implementable method of frequency-selective control of a power of an Uplink (UL) channel transmission by User Equipment (UE);

FIG. 2 illustrates a schematic representation of a Transmission-Reception Point (TRP);

FIG. 3 illustrates a flowchart of User Equipment (UE)-implementable method of frequency-selective control of a power of an Uplink (UL) channel transmission to a Transmission-Reception Point (TRP);

FIG. 4 illustrates a schematic representation of User Equipment (UE);

FIG. 5 illustrates a schematic representation of a communication system;

FIG. 6 illustrates a visual comparison of a conventional MU-MIMO and the MU-MIMO with frequency-selective transmit power control proposed in this application;

FIG. 7 illustrates an exemplary scheme for adjusting a transmit power in each sub-band relative to a reference transmit power level common to all the sub-bands;

FIG. 8 illustrates an exemplary scheme for adjusting a transmit power in each sub-band relative to a transmit power level in the previous sub-band;

FIG. 9 is a cumulative distribution function (CDF) for UE performance in megabits per second (Mbps) visually illustrating the performance gain of the User Equipment (UE) located close to a cell edge and applying the frequency-selective transmit power control;

FIG. 10 illustrates a block diagram illustrating a structure of a UE according to various embodiments of the present disclosure; and

FIG. 11 illustrates a block diagram illustrating a structure of a base station according to various embodiments of the present disclosure, as disclosed herein.

### MODE FOR THE INVENTION

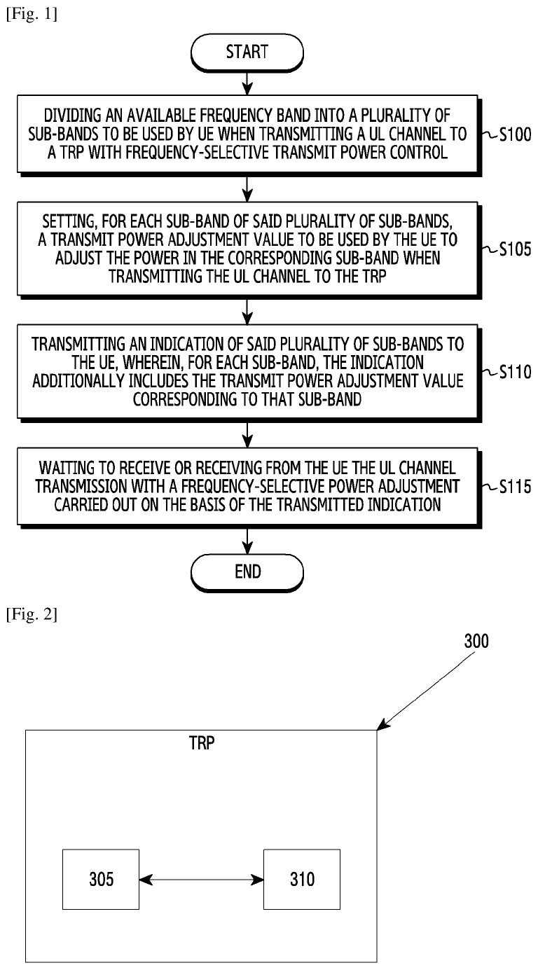

FIGS. 1-11, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

A 6G system, which, as expected, may be deployed as one of possible variants in the upper-middle frequency band (10-12 GHz), will support massive phased MIMO antenna arrays (≥1024 antenna elements) with hybrid analog and digital beamforming at a Transmit-Receive (transmission/reception) Point (TRP) with a large number of digital antenna ports (≥128). At the same time, a multi-user (MU) MIMO mode in both a downlink (DL) and an Uplink (UL), which allows one User Equipment (UE) to receive and/or transmit signals simultaneously with other UEs on the same frequencies, is considered as a very attractive technology for the 6G system with extreme MIMO (xMIMO) to unlock the full potential of the sixth generation communications.

Orthogonal Frequency Division Multiple Access (OFDMA) is considered as one of candidate access schemes for multiple UEs in the 6G system. Frequency-selective scheduling of time-frequency resources for data transmission/reception is typical for OFDMA. However, the use of MU-MIMO with frequency-selective scheduling in OFDMA generally results in that a different number of UEs transmits/receives a data signal simultaneously within an available frequency band per unit time.

The UL transmit power control specifies the power of signals/channels transmitted within the UL, for example, a Physical Uplink Shared Channel (PUSCH), to reduce mutual interference and UE power consumption. The conventional Transmit Power Control (TPC) in an UL in the fifth generation (5G) ‘new radio’ (NR) communication system includes two components (members): an autonomous component and a feedback-based component. The autonomous component (open-loop term) is determined autonomously by the UE based on DL measurements. The feedback-based (i.e., non-autonomous) component (closed-loop term) is determined from a downlink control information (DCI) transmitted from the TRP to the UE.

In the 6G system, the use of xMIMO will provide MU-MIMO with a much larger number of UEs that can transmit UL simultaneously on the same resource blocks (RBs) than in conventional 5G NR massive MIMO communication systems. Thus, a remarkably greater total transmit power level in MU-MIMO can result in increased inter-cell interference (ICI) that is spatially isotropic due to a plurality of randomly distributed UE sources. The increased ICI in MU-MIMO may, in turn, result in degrading UE performance at the cell edge in the UL.

In addition, the use of a conventional (i.e., not frequency-selective) UL power control scheme for MU-MIMO that uses one common transmit power adjustment value may result in interference being more frequency-selective due to (1) a different number of UEs transmitting UL simultaneously on the same frequency resources and (2) making different decisions on pairing of simultaneous UL transmissions of different UEs on the same frequencies. In other words, in this case, the total power spectral density (PSD) of such transmissions becomes non-uniform in frequency.

As a closest prior art, a technical solution described in a U.S. Pat. No. 9,661,592 B2, published on 23 May 2017 and entitled ‘UPLINK POWER CONTROL METHOD AND APPARATUS IN A BEAM-FORMING BASED WIRELESS COMMUNICATION SYSTEM’ has been considered. However, the known technical solution lacks transmit power control adaptation in a frequency domain, therefore the known technical solution suffers from one or more of the problems described above.

FIG. 1 illustrates a flowchart of a Transmission-Reception Point (TRP)-implementable method of frequency-selective control of a power of an Uplink (UL) channel transmission by User Equipment (UE) according to the first aspect of the present invention. The method starts and proceeds to performing a S100 step, in which an available frequency band is divided (partitioned) into a plurality of frequency sub-bands to be used by the UE in frequency-selective power control of transmitting the UL channel to the TRP. The UL channel may be a Physical Uplink Shared Channel (PUSCH) and the available frequency band may be any operating frequency band that is used for communication between the TRP and the UE, including that currently used for 4G LTE, Pre-5G, 5G NR, etc. Non-limiting examples of the available frequency band to be divided into sub-bands in the S100 step may include a frequency band 1 (FR1) up to 7.125 GHz or at least a part thereof, a frequency band 2 (FR2) from 24.25 GHz to 71 GHz or at least a part thereof, or a frequency band from 7.125 GHz to 24.25 GHz, or at least a part thereof.

The dividing of the entire available frequency band into the sub-bands in the S100 step can be performed by any suitable manner and may occur, for example, when performing an RRC procedure between the TRP and the UE. In a possible embodiment, the dividing may be performed along a selectable fixed layout, for example, along the boundaries of one, two or more RBs or REs. In another possible embodiment, a total number of sub-bands may be chosen, which should be obtained by dividing the entire frequency band available for dividing. Thus, the dividing S100 of the available frequency band may be performed by dividing into the plurality of sub-bands of a same width or into the plurality of sub-bands of different width. Such dividing may be performed dynamically (or, in other words, adaptively when one band obtained by dividing is wider or narrower than one or more other bands obtained by dividing) according to the frequency resources allocated for UL transmissions by frequency-selective resource scheduling used in OFDMA, employed together with MU-MIMO.

As a non-limiting illustration of dividing, the right side of FIG. 6 schematically shows an example of dividing an available frequency band into frequency sub-bands 1 to 3 for performing UL transmissions by four UEs (UE1, UE2, UE3, UE4). The sub-band 1 includes five resource blocks (RBs) from RB1 to RB5, the sub-band 2 includes five resource blocks from RB6 to RB10, the sub-band 3 includes two resource blocks from RB11 to RB12. The boundaries of sub-bands obtained by dividing (for example, the illustrated sub-bands 1 to 3) may be determined depending on a number of Ues transmitting simultaneously within this sub-band and/or depending on a power adjustment value to be set for Ues transmitting simultaneously within this sub-band.

As a non-limiting example, it may be determined that the boundary of the sub-band 1 passes along the boundary between RB5 and RB6, since in each RB from RB1 to RB5, a number of Ues transmitting simultaneously is equal to 3, and starting from RB6 (inclusive) this number changes to 2. In another non-limiting example, it may be determined that the boundary of the sub-band 1 passes along the boundary between RB5 and RB6, since in each RB from RB1 to RB5, the transmit power adjustment value of each UE from UE1 to UE4 is the same, and starting from RB6 (inclusive) this value changes. In similar manners, the boundaries between other adjacent sub-bands (for example, between the sub-bands 2 and 3 illustrated in FIG. 6) obtained by dividing at the S100 step can be determined. The resource blocks are used only as an example, in an alternative variant, sub-bands may be determined by a number of smaller in width portions of the available frequency band (for example, a number of Resource Elements (REs)), or a number of greater in width portions of the available frequency band. Thus, the sub-band may include one or more RBs or one or more REs.

In another possible implementation, the dividing of the available frequency band at the S100 step can be performed by initially dividing the entire available frequency band into a plurality of sub-bands of a same width (for example along the boundaries of one RB/RE, i.e., one sub-band is equal to one RB/RE; or along the boundaries of two adjacent RB/RE, i.e., one sub-band is equal to two RB/RE, etc.), with subsequent determining, for each such sub-band, a corresponding power adjustment value, and combining the adjacent sub-bands for which the same power adjustment value is determined into one sub-band. This possible implementation can further reduce an amount of the control information signalized on the UE (for example, to decrease of a total number of signalized TPC commands).

The start and end (i.e., boundaries) of each sub-band obtained by dividing at the S100 step may be indicated, but not limited to, by an index of the first RE or RB of the sub-band and an index of the last RE or RB of the sub-band (in the example shown on the right of FIG. 6: for the sub-band 1: by a RB1 index and a RB5 index); or by an index of the first RE or RB of the sub-band and a number of REs or RBs in the sub-band (in said example: for the sub-band 1: by a RB1 index and the number 5 (if the RB1 itself is considered/taken into account) or 4 (if the RB1 itself is not considered/not taken into account); or by an index of the first RE or RB of the sub-band, and by an index of the first RE or RB of the next sub-band (in said example: for the sub-band 1: by the RB1 index and RB6 index). The sub-bands obtained as a result of dividing at the S100 step (together with corresponding power adjustment values, determination of which will be described in detail below) may be signalized on the UE from the TRP by one or more indications. Such indications may be, but not limited to, a TPC command in the DCI message or in the RRC procedure configuration message.

After performing the S100 step, the method proceeds to performing a S105 step, in which setting, for each sub-band of said plurality of sub-bands, the transmit power adjustment value δ to be used by the UE to adjust the power in the corresponding sub-band when transmitting the UL channel to the TRP. In one non-limiting example of the implementation of this step, the TRP may select the value δ of the transmit power adjustment for the frequency sub-band depending on a number of UEs transmitting within the frequency band. If N of the UEs transmit simultaneously, the TRP selects, from the possible pre-configured transmit power adjustment values available for the TPC command in the DCI message or in the RRC procedure configuration message, the value δ closest to −10*log 10 (N) dB. So, if two UEs transmit simultaneously, the transmit power of each is to be reduced by 2 times, i.e., δ=−10*log 10 (2)≈−3 dB. In case of transmitting a single UE in the sub-band, the transmit power adjustment value δ will be equal to δ=−10*log 10 (1)=0 dB; in this case, such a value δ may, for a corresponding sub-band in the indication, not be signalized on the UE, and lack of a transmit power adjustment value δ for the sub-band in the indication received from the TRP may be interpreted by the UE such that the transmit power should not be adjusted for this sub-band. In general, the disclosed technology should not be limited by the above example of implementation of this step, since the TRP may select the transmit power adjustment value δ for the frequency sub-band not only based on a number of users in the MU-MIMO transmission mode for a certain frequency sub-band, but in any suitable random method. For example, the value δ may be selected so as to decrease a power at a certain frequency band, where it will not result in deteriorating the immunity to interference of transmission from the UE to the TRP. This will allow the total power of the UE transmitter to be reduced, and thereby operating time from one charging of the UE battery to be increased.

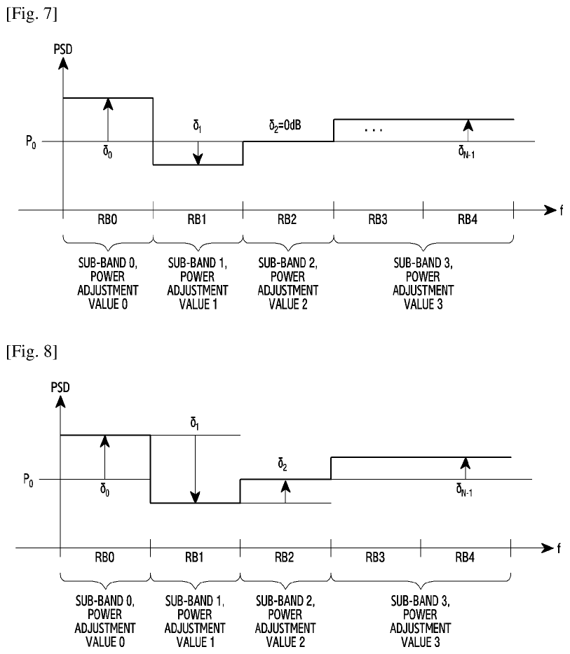

In a possible implementation, the transmit power adjustment value in each sub-band may be set relative to a reference transmit power level P₀ common to all the sub-bands as shown in FIG. 7. Generally, the reference transmit power level P₀ value common to all the sub-bands coincides with a target power spectral density (PSD₀) value that is determined for a single user in a sub-band, i.e., for a single user (SU)-MIMO. Therefore, in order to set the transmit power adjustment value δ for a frequency sub-band in this case relative to the common reference power level P₀, this value may, in a non-limiting example, be set so as described above, i.e., δ=−10*log 10 (N) dB.

In another possible implementation, the transmit power adjustment value in each sub-band may be set relative to a transmit power level in the previous sub-band as shown in FIG. 8. A non-limiting example of the setting of a transmit power adjustment value δ for the (i+1)^{th} sub-band in this case may be: δ=10*log 10 (Nᵢ/Nᵢ₊₁) dB, where Nᵢ is a number of MU-MIMO users in the i^{th} sub-band and Nᵢ₊₁ is a number of MU-MIMO users in the (i+1)^{th} sub-band.

After performing the S105 step, the method proceeds to perform a S110 step, wherein an indication of said plurality of sub-bands and corresponding set transmit power adjustment values δ are transmitted to the UE. The transmission may be performed over a communication network in which the TRP and UE are members. In a possible implementation, said indication is, but not limited to, a TPC command in the DCI message or in the RRC procedure configuration message. In another possible embodiment, the TPC command may be transmitted to the UE in another message, for example, in a separate message to the TPC command, i.e., in the TPC command message. Furthermore, it should be noted that the indication may include transmitting a plurality of individual TPC commands, each of which signalizes a certain sub-band and its corresponding transmit power adjustment value δ, or, alternatively, may include transmitting one common TCP command indicating all the sub-bands obtained by dividing at the S100 step and the corresponding transmit power adjustment values δ.

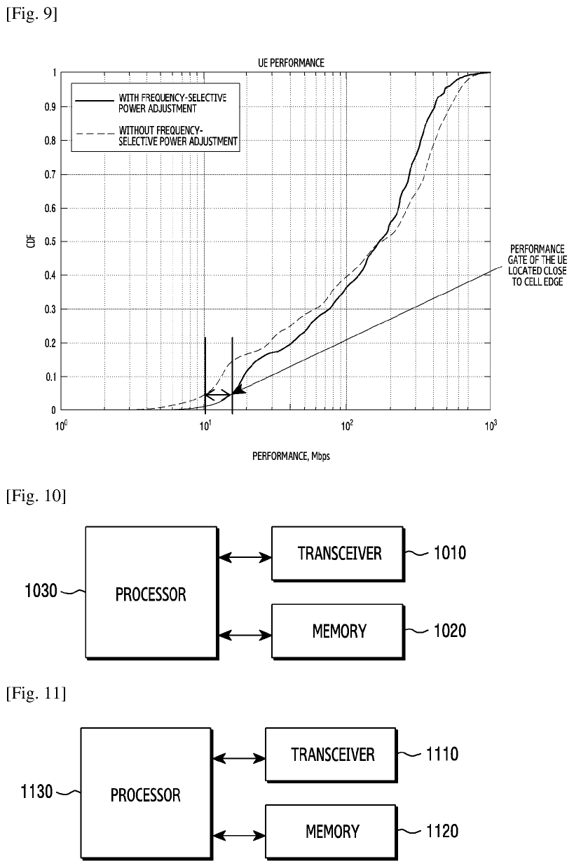

After performing the S110 step, the method proceeds to perform a S115 step, in which the TRP waits for receiving or receives from the UE the channel UL transmission with a frequency-selective power adjustment which has been performed by the UE based at least on the information comprised in the indication transmitted in the S110 step. In an alternative embodiment, the method may proceed to perform a step (not shown in FIG. 1), in which the TRP waits for from the UE the channel UL transmission with a frequency-selective power adjustment which has been performed by the UE based at least on the information comprised in the indication transmitted at the S110 step. The frequency-selective power adjustment carried out on the basis of the transmitted indication reduces a total power level of the UL transmission in the MU-MIMO mode in wireless communication systems with frequency-selective resource scheduling OFDMA. In other words, the frequency-selective power adjustment carried out on the basis of the transmitted indication is a finer power adjustment that modifies the Spectral Power Density (PSD) downwards and equalizes it over the entire available frequency band subjected by dividing at the S100 step (compare the left side of FIG. 6 to its right side), resulting in the decrease in inter-cell interference (ICI) and a performance gain (see FIG. 9) of the UL transmissions performed by the UEs located close to a cell edge.

At the same time, the decrease in the UE transmit power in a certain sub-band is not an problem because this decreased UE transmit power will still be sufficient for error-free reception of data from the UE on the TRP side. Sufficiency/insufficiency may, in a non-limiting example, be controlled by the TRP side: for example, a large number of users (exceeding a predetermined threshold value of a number of users per sub-band) may not be put in one frequency sub-band in the MU-MIMO mode, if such transmission mode may result in such a power drawdown (exceeding a predetermined power drawdown threshold) of a transmitter of any of the UEs, at which the UE transmit power would be insufficient to error-free receive data signals from that UE.

In a possible implementation, a dynamic range of possible power adjustment values may be expanded, if necessary, by using, in the DCI message or the RRC configuration message, additional TPC command bit values indicating additional transmit power adjustment values. In a non-limiting example, the additional (new) transmit power adjustment values for the TPC command may be configured to be used in signaling the power adjustment value in the DCI message, as follows:

TABLE 1

| | | Accumulated power | Absolute power |
|---|---|---|---|
| | | adjustment | adjustment |
| TPC | | value, dB | value, dB |
| 000 | | −1 | −4 |
| 001 | | 0 | −1 |
| 010 | | 1 | 1 |
| 011 | | 3 | 4 |
| New bit values and | 100 | −3 | −7 |
| corresponding configurable | 101 | −5 | −10 |
| power adjustment values: | 110 | 5 | −13 |
| | 111 | 7 | −16 |

Table 1 refers additional bits for the TPC command.

Absence of some specific power adjustment values (for example, 2 dB, 6 dB) in Table 1 is not to be interpreted in the sense that such specific values are not applicable. Instead, such absence is explained only by a limited number of bits coding the power levels, i.e., more additional power levels may be set by a larger number of corresponding bit values and signalized in the DCI message. Thus, in the actual implementation, the specific dB values indicated in the columns of the above Table 1 ‘Accumulated power value, dB’ and ‘Absolute power value, dB’ are not to be interpreted as limitation, i.e., as the only possible values since other specific dB values may be provided in dependence on the implementation. In addition, the dynamic range of power adjustment values may be extended even further by coding additional TPC commands by a larger number of bits, for example, by four bits, five bits, etc.

In another non-limiting example, the additional (new) transmit power adjustment values for the TPC command may be dynamically configured and signalized in the RRC procedure configuration message. In this case, the content of the RRC procedure configuration message boxes may be set as shown in the following Table 2:

TABLE 2

| | Accumulated power adjustment | Absolute power adjustment |
|---|---|---|
| TPC | value, dB | value, dB |
| 00 | Particular value is dynamically | Particular value is dynamically |
| | configured by RRC procedure | configured by RRC procedure |
| 01 | Particular value is dynamically | Particular value is dynamically |
| | configured by RRC procedure | configured by RRC procedure |
| 10 | Particular value is dynamically | Particular value is dynamically |
| | configured by RRC procedure | configured by RRC procedure |
| 11 | Particular value is dynamically | Particular value is dynamically |
| | configured by RRC procedure | configured by RRC procedure |

Table 2 refers an RRC configuration for TPC command power adjustment values.

Due to such approach, it is possible to dynamically (as required) change the range width while transmitting corresponding changes to the UE by the respective RRC procedure configuration message. Thus, the technical solution proposed in this disclosure is adapted to operate with very large variations in a number of the scheduled UEs, which is particularly attractive for operation and support with xMIMO. In addition, it also facilitates reducing interference to other cells when using the MU-MIMO.

FIG. 2 illustrates a schematic representation of a Transmission-Reception Point (TRP, 300) according to a second aspect of the present invention, which is configured to perform the method according to the first aspect of the present invention due to at least that it includes a receiving-transmitting antenna unit 305 configured to communicate with a UE and with any other devices being within the coverage area of the respective cell, and a processor 310 operatively coupled to the receiving-transmitting antenna unit 305 and configured to perform the method according to the first aspect of the present invention or according to any possible implementation of the first aspect of the present invention. The Transmission-Reception Point (TRP) may be, but not limited to, a Base Station (BS), an Access Point (AP), or a Node B (NodeB).

The TRP 300 is shown in FIG. 2 in a relatively simplistic, schematic form, therefore not all components contained in the TRP 300 are shown in the figure, but only those due to which the present invention is implemented. As known, the TRP may contain other components not shown in the figure, for example, a power supply, various interfaces, I/O means, interconnections, a random access memory and a read-only (non-volatile) memory storing processor-executable 310 instructions to perform the method according to the first aspect of the present invention or according to any possible implementation of the first aspect of the present invention, as well as an operating system, etc. The transmitting-receiving antenna unit 305 may contain a transceiver and an antenna coupled to each other. The antenna can be implemented as a massive or extremely massive MIMO antenna array with a large number of antenna ports that supports hybrid analog and digital beamforming capability.

The processor 310 of the TRP 300 may be a CPU, a special-purpose processor, another processing unit, for example, a graphical processing unit (GPU), or a combination thereof. The 310 processor may be implemented as a chip, for example as a Field-Programmable Gate Array (FPGA), an Application-Specific Integrated Circuit (ASIC), a System-on-Chip (SoC), etc.

FIG. 3 illustrates a flowchart of User Equipment (UE)-implementable method of frequency-selective control of a power of an Uplink (UL) channel transmission to the Transmission-Reception Point (TRP) according to the fourth aspect of the present invention. The method starts and proceeds to perform a S200 step in which an indication of a plurality of sub-bands obtained by dividing (partitioning) an available frequency band and to be used by the UE when transmitting the UL channel to the TRP with frequency-selective transmit power control is received from the TRP. The UE receives said indication from the TRP, within whose cell the UE is currently positioned.

The received indication further includes, for each sub-band, a transmit power adjustment value set for the sub-band and to be used by the UE to adjust the power in this sub-band when transmitting the UL channel to the TRP. If there is no need for a certain sub-band to perform the transmit power adjustment, said indication for this sub-band may include a transmit power adjustment value δ being equal to 0 dB, or, in such a case, the indication for such a sub-band may contain no transmit power adjustment value δ, but thereby signalizing to the UE that there is no need for the transmit power adjustment to be performed for this sub-band.

Upon completion of the S200 step, the method proceeds to perform a S205 step in which the UL channel with the performed frequency-selective power adjustment carried out on the basis of the received indication is transmitted to the TRP. The plurality of transmit power adjustment values in the indication control the PSD of the transmitter in corresponding sub-bands (groups) of frequency resources (RBs or REs). Hence, the total PUSCH power according to the new Equation 1 below is a sum of powers in each sub-band limited from above by a maximum power of the UE transmitter. Thus, the new UE (transmitter) transmit power equation for PUSCH (in a linear expression) is the following Equation 1:

$${\hat{P}}_{PUSCH} = min ( {\hat{P}}_{CMAX} , {\sum }_{n = 0}^{N - 1} {\hat{P}}_{n}^{sub - band} ) \qquad ( Equation 1 )$$

where \hat{P}_{CMAX} is a linear value of maximum permitted power P_{CMAX} of the UE transmission, this value may be signalized on the UE in the configuration message from the Transmission-Reception Point (TRP), and, as an alternative, in some cases, this value may be a maximum output power of the UE transmitter,

$${\hat{P}}_{n}^{sub - band}$$

is a linear power value

$${P}_{n}^{sub - band}$$

of the UE transmission [decibel-milliwatts, dBm (in logarithmic expression)] in n^{th} sub-band (n∈{0, 1, . . . , N−1}), and
N is a total number of frequency sub-bands in the resource allocation for the PUSCH transmission.

The power

$${P}_{n}^{sub - band}$$

of the UL transmission [dBm] in n^{th} sub-band (n∈{0, 1, . . . , N−1}) is determined according to the following new Equation 2 proposed in the present disclosure, which is based on a modification of a respective component of the UL power control equation for 5G NR (see Section 7.1 in TS 38,214) that is applied to determine the transmit power [dBm] within the UE. The new Equation 2 may be written as follows:

$${P}_{n}^{sub - band} = {P}_{0} + 10 \cdot {log}_{10} ( {2}^{μ} \cdot {M}_{RB}^{sub - band} ) + α \cdot PL + {Δ}_{TF} + {δ}_{n} \qquad ( Equation 2 )$$

where P₀ is a target receive/transmit power spectral density (PSD) per one 15 kHz physical resource block (PRB), provided that there is full pathloss compensation, preconfigured by the Transmission-Reception Point (TRP) and to be transmitted in the RRC configuration message, wherein this target PSD can be considered as a reference power level P₀, with respect to which, as shown in FIG. 7, in a possible embodiment of the present invention, the transmit power level is adjusted in each sub-band,
μ is numerology adjustment factor, μ={0, 1, 2, 3, 4} to reflect spacing between separate orthogonal subcarriers different from the 15 kHz reference spacing,

$${M}_{RB}^{sub - band}$$

is a number of RBs allocated for PUSCH,
α is a loss compensation control factor in the path α∈[0,1], in said range, the extreme value α=0 means total absence of pathloss compensation, and the another extreme value α=1 means full pathloss compensation,
PL is a loss estimate in the path between TRP and UE,
Δ_{TF} is an optional (i.e., may not be present) power offset associated with a selected Modulation and Coding Scheme (MCS), and
δₙ is a transmit power adjustment value particularly for the n^{th} sub-band signalized by the indication that is received in the S200 step, a number of values δₙ is equal to a number of sub-bands obtained by dividing; if the value δₙ is absent in the indication, it is determined that this value is equal to 0 dB (i.e., the transmit power adjustment for PUSCH for the respective sub-band is not performed by the UE).

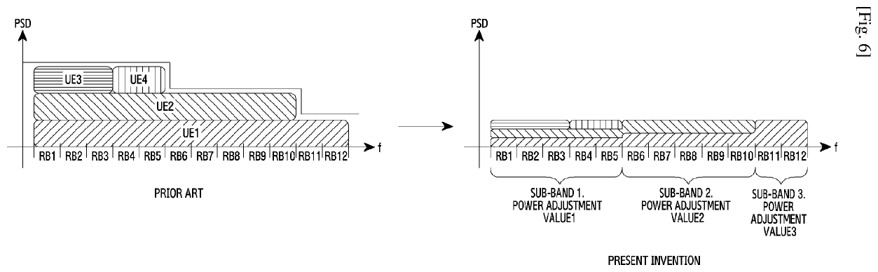

The above Equation 1 and Equation 2 are employed at the UE to perform a frequency-selective power adjustment of the UL channel (PUSCH) transmission to the TRP. Such a power adjustment allows, as indicated above, for reducing inter-cell interference (for example, ICI interference generated by the UE 400 transmissions to the TRP 300 in a cell 1 and adversely affecting cells 2 and 3 what is illustrated in FIG. 5) and providing the increase as illustrated in FIG. 9, in a data rate gain of uplink by UEs located close to a cell edge.

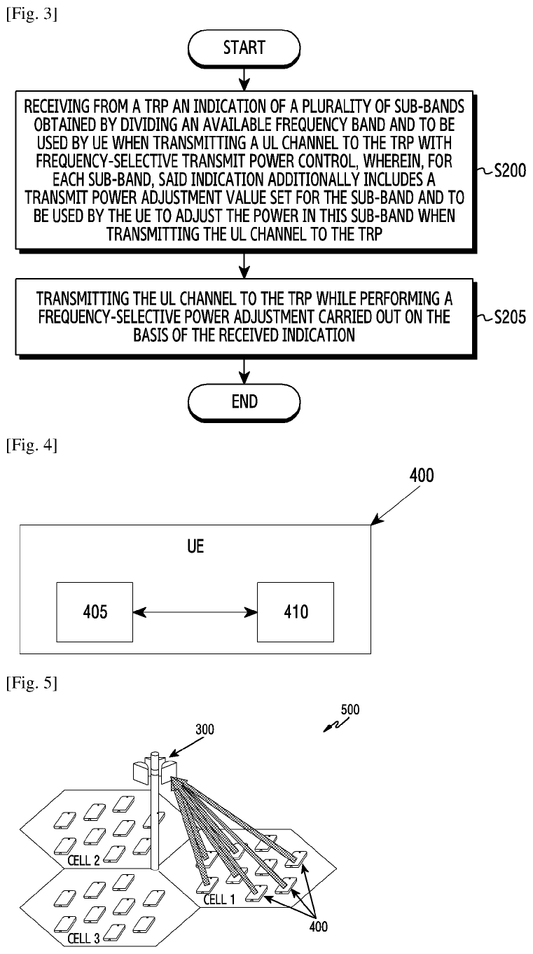

FIG. 4 illustrates a schematic representation of User Equipment (UE, 400) according to a fifth aspect of the present invention, which is configured to perform the method according to the fourth aspect of the present invention due to at least that it includes a transmitting-receiving antenna unit 405 configured to communicate with a TRP and with any other devices being within the coverage area of the corresponding cell, and a processor 410 operatively coupled to the transmitting-receiving antenna unit 405 and configured to perform the method according to the fourth aspect of the present invention or according to any possible implementation of the fourth aspect of the present invention. The UE may be, but not limited to, a mobile phone, a tablet, a laptop, a personal computer, a user wearable electronic device (for example, glasses, watch), a AR/VR head and chest set, an ‘Internet of Things’ (IoT) device, an equipment hosted in a vehicle, or any other electronic mobile communication device. The UE may be referred differently, for example, as a user terminal, a user device, a subscriber equipment, etc.

The UE 400 is shown in FIG. 4 in a relatively simplistic, schematic form, therefore not all components comprised actually in the UE 400 are shown in this figure, but only those due to which the present invention is implemented. As known, the TRP may contain other components not shown in the figure, for example, a power supply, various interfaces, I/O means, interconnections, a random access and read-only (non-volatile) memory storing processor (410)-executable instructions to perform the method according to the fourth aspect of the present invention or according to any possible implementation of the fourth aspect of the present invention, as well as an operating system, etc. The transmitting-receiving antenna unit 405 may contain a transceiver and an antenna coupled to each other. The antenna can be implemented as a massive or extremely massive MIMO antenna array with a large number of antenna ports that supports hybrid analog and digital beamforming capability.

The processor 410 of the UE 400 may be a central processing unit (CPU), a special-purpose processor, another processing unit, for example, a graphical processing unit (GPU), or a combination thereof. The 410 processor may be implemented as a chip, for example, as a Field-Programmable Gate Array (FPGA), an Application-Specific Integrated Circuit (ASIC), a System-on-Chip (SoC), etc.

FIG. 5 illustrates a schematic representation of a communication system 500 according to the seventh aspect of the present invention. The communication system 500 comprises one TRP 300 that is installed to operate the UEs 400 in three deployed cells 1, 2, 3. The Transmission-Reception Point 300 may corresponds to the TRP 300, which is described above in detail with reference to FIG. 2, and each UE 400 may corresponds to the UE 400, which is described in detail with reference to FIG. 4, therefore, the detailed description of the TRP 300 and the UE 400 is not provided here again. The communication system 500 may support any radio access technology (RAT), for example, 4G LTE, 5G NR, 6G, or a combination thereof. In the latter case, i.e., when the communication system 500 supports multiple radio access technologies, a dynamic division of a frequency spectrum may be used in the communication system 500.

Particular details shown in FIG. 5 should not be construed as limiting the present technology, since the system 500 may have a different architecture and may be characterized/illustrated otherwise, for example, each cell from the cell 1, cell 2, cell 3 may correspond to its own TRP 300, a number of UE 400 in the cells may differ from the one shown, the cells 1, 2, 3 may be a single greater cell, a shape and space covered by the cells may differ from the ones shown, etc.

FIG. 6 visually illustrates a comparison of a conventional MU-MIMO and the MU-MIMO with frequency-selective transmit power control proposed in this application. The left side of the figure corresponds to the prior art and the right side of the figure corresponds to the present invention, in which the frequency adaptive power adjustment is used. As seen from the left side of the figure, lack of the dynamic power adjustment of the power in dependence on frequency results in the prior art in that the power spectral density of all uplink transmissions performed by the UEs (UE1, UE2, UE3, UE4) is non-uniform. The right side shows the total power spectral density of the UE1, UE2, UE3, UE4 transmissions received on the TRP, for which each of the UE1, UE2, UE3, UE4 has preliminarily applied the frequency-selective power adjustment according to the indication received from the TRP early. Thus, due to the present invention, the PSD of transmissions of individual UEs in different sub-bands may be dynamically adjusted in dependence on a number of the UEs transmitting simultaneously (in accordance with resource scheduling performed by the TRP) in the corresponding sub-bands, but the total integrated PSD of transmissions of all the UEs received by the TRP receiver remains uniform, which results to decreasing the mutual inter-cell interference and provides a performance gain of the UEs being near the cell edge.

FIG. 7 illustrates an exemplary scheme for adjusting a transmit power in each sub-band relative to a reference (target) transmit power level P₀ common to all the sub-bands. As mentioned above, generally, the reference transmit power level P₀ value common to all the sub-bands coincides with a target power spectral density (PSD₀) value that is determined for a single user in a sub-band, i.e., for a single user (SU)-MIMO. Therefore, in order to set the transmit power adjustment value δ for the frequency sub-band in this case relative to the common reference power level P₀, this value may, in a non-limiting example, be set as δ=−10*log 10 (N) dB. The advantage of this implementation is that the adjustment in this case is performed in a more precise manner, but more bits are used.

FIG. 8 illustrates an exemplary scheme for adjusting a transmit power in each sub-band relative to an adjusted transmit power level in the previous sub-band. A non-limiting example of the setting of a transmit power adjustment value δ for the (i+1)^{th} sub-band in this case may be: δ=10*log 10 (Nᵢ/Nᵢ₊₁) dB, where Nᵢ is a number of MU-MIMO users in the i^{th} sub-band and Nᵢ₊₁ is a number of MU-MIMO users in the (i+1)^{th} sub-band. In this possible implementation, for the first sub-band (i.e., the sub-band 0 in FIG. 8), the first adjustment value (i.e., value do in FIG. 8) will nevertheless be set with respect to a certain level, for example, but not limited to, the reference (target) transmit power level P₀ mentioned in respect to FIG. 7 or the last adjusted transmit power level in the directly preceding time resource. Thus, the value δ₀ for the sub-band 0 in FIG. 8 may be set as δ₀=−10*log 10 (N₀) dB, where N₀ is a number of MU-MIMO users in the 0^{th} sub-band. The advantage of this implementation is that a smaller number of bits are required to signalize the power adjustment values δ.

FIG. 9 shows an experimental data obtained by the authors of the present disclosure in a network simulator and a presentation in the graph form of cumulative distribution functions (CDFs) of data rate values for the UE in megabits per second (Mbps), which visually illustrate the beneficial effect of applying the disclosed invention, namely a performance gain of the UEs located near the cell edges (note in the figure the representative five percent distribution level of the UEs in this regard) applying the frequency-selective transmit power control according to the present disclosure (see solid line) versus the performance of the UE applying no such frequency-selective transmit power control (see dashed line).

FIG. 10 illustrates a block diagram illustrating a structure of a UE according to various embodiments of the present disclosure. FIG. 10 corresponds to the example of the UE of FIG. 4.

As shown in FIG. 10, the UE according to an embodiment may include a transceiver 1010, a memory 1020, and a processor (e.g. controller) 1030. The transceiver 1010, the memory 1020, and the processor 1030 of the UE may operate according to a communication method of the UE described above. However, the components of the UE are not limited thereto. For example, the UE may include more or fewer components than those described above. In addition, the processor 1030, the transceiver 1010, and the memory 1020 may be implemented as a single chip. Also, the processor 1030 may include at least one processor.

The transceiver 1010 collectively refers to a UE receiver and a UE transmitter, and may transmit/receive a signal to/from a base station. The signal transmitted or received to or from the base station may include control information and data. The transceiver 1010 may include a RF transmitter for up-converting and amplifying a frequency of a transmitted signal, and a RF receiver for amplifying low-noise and down-converting a frequency of a received signal. However, this is only an example of the transceiver 1010 and components of the transceiver 1010 are not limited to the RF transmitter and the RF receiver.

Also, the transceiver 1010 may receive and output, to the processor 1030, a signal through a wireless channel, and transmit a signal output from the processor 1030 through the wireless channel.

The memory 1020 may store a program and data required for operations of the UE. Also, the memory 1020 may store control information or data included in a signal obtained by the UE. The memory 1020 may be a storage medium, such as read-only memory (ROM), random access memory (RAM), a hard disk, a CD-ROM, and a DVD, or a combination of storage media.

The processor 1030 may control a series of processes such that the UE operates as described above. For example, the transceiver 1010 may receive a data signal including a control signal transmitted by the base station, and the processor 1030 may determine a result of receiving the control signal and the data signal transmitted by the base station.

FIG. 11 illustrates a block diagram illustrating a structure of a base station according to various embodiments of the present disclosure. FIG. 11 corresponds to the example of the TRP of FIG. 2.

As shown in FIG. 11, the base station according to an embodiment may include a transceiver 1110, a memory 1120, and a processor (e.g. controller) 1130. The transceiver 1110, the memory 1120, and the processor 1130 of the base station may operate according to a communication method of the base station described above. However, the components of the network entity are not limited thereto. For example, the base station may include more or fewer components than those described above. In addition, the processor 1130, the transceiver 1110, and the memory 1120 may be implemented as a single chip. Also, the processor 1130 may include at least one processor.

The transceiver 1110 collectively refers to a base station receiver and a base station transmitter, and may transmit/receive a signal to/from a terminal. The signal transmitted or received to or from the terminal may include control information and data. The transceiver 1110 may include a RF transmitter for up-converting and amplifying a frequency of a transmitted signal, and a RF receiver for amplifying low-noise and down-converting a frequency of a received signal. However, this is only an example of the transceiver 1110 and components of the transceiver 1110 are not limited to the RF transmitter and the RF receiver.

Also, the transceiver 1110 may receive and output, to the processor 1130, a signal through a wireless channel, and transmit a signal output from the processor 1130 through the wireless channel.

The memory 1120 may store a program and data required for operations of the base station. Also, the memory 1120 may store control information or data included in a signal obtained by the base station. The memory 1120 may be a storage medium, such as read-only memory (ROM), random access memory (RAM), a hard disk, a CD-ROM, and a DVD, or a combination of storage media.

The processor 1130 may control a series of processes such that the network entity operates as described above. For example, the transceiver 1110 may receive a data signal including a control signal transmitted by the terminal, and the processor 1130 may determine a result of receiving the control signal and the data signal transmitted by the terminal.

The technical decision disclosed in the present application and consisting in the dynamic frequency-selective transmit power adjustment lowers the total power level of UL MU-MIMO data transmissions in wireless systems with frequency-selective scheduling with OFDMA. Thus, the inter-cell interference is reduced and the data rate of the UEs located near the cell edges is increased.

The present invention further may be implemented as a storage medium storing processor-executable instructions which, when executed by a processor of a device equipped with a transmitting-receiving antenna unit, allow for performing the method according to any aspect of the disclosed invention or according to any possible implementation of the corresponding aspect. The storage medium may be any long-term (non-transitory) computer-readable medium, a memory, a memory area, a storage device, etc., for example, but not limited to, a hard disk, an optical medium, a semiconductor medium, a Solid State (SSD) storage device or similar.

The invention can be used in the TRP employing a massive MIMO antenna technology with a very large number of digital antenna ports (for example, ≥128). The invention can be used in the wireless system employing advanced MU-MIMO transmission schemes where multiple UEs transmit UL data signals simultaneously over the same frequencies. In addition, the invention can be used in the wireless system employing the OFDMA technology for multiple access in an uplink. Finally, the present invention can be used in a wireless cellular communication system with a massive MIMO antenna that utilizes an upper part of the medium frequency band (10-13 GHz), operates in a time division duplex (TDD) mode (with unpaired spectrum), and complies with the 3GPP Specification.

At least one aspect of the disclosed technical solution can be implemented by an AI model. The function associated with the AI can be performed by a read-only memory, a random access memory, and processor(s) (CPU, GPU, NPU). The processor(s) controls the processing of input data in accordance with a predefined operating rule or an artificial intelligence (AI) model stored in the read-only memory and random access memory. The predefined operation rule or artificial intelligence model is provided by means of training. Here, “providing by means of training” means that, by applying the learning algorithm to the plurality of training data, a predefined operation rule or an AI model with a required characteristic (for example, an AI model for determining values of different parameters (for example, a transmit power adjustment value δ) from values of other parameters, or an AI model for determining a scheme for dividing an available frequency band into sub-bands in one or another case according to the determined communication parameters values between the TRP and the UE) is generated. Such learning can be performed in the device itself in which AI according to an embodiment is used, and/or can be implemented through a separate server/system.

The AI model can be a decision tree based algorithm or can consist of a plurality of neural network layers. Each layer has a plurality of weight values and a layer operation is performed by calculating, based on a calculation in a previous layer and applying a plurality of weights (weighting factors) and values of other parameters. Examples of the decision tree based algorithms include a random forest, tree ensembles, etc., and examples of the neural networks include, among other things, Convolutional Neural Network (CNN), Deep Neural Network (DNN), Recurrent Neural Network (RNN), Restricted Boltzmann Machine (RBM), Deep Belief Network (DBN), Bi-directional Network, Bi-directional Recurrent Deep Neural Network (BRDNN), Generative Adversarial Network (GAN), Transformer-based Architecture Networks, Deep Q-Network, etc.

The learning algorithm is a method for training a predetermined target device or a target function based on a corresponding plurality of training data that calls, enables, controls or provides output data of the target device or the target function. Examples of the training algorithms include, but not limited to, supervised learning, unsupervised learning, semi-supervised learning or reinforcement learning, etc.

It can be understood to a person skilled in the art that various illustrative logic units (functional units or modules) and steps (operations) used in embodiments of the disclosed technical solution can be implemented by electronic hardware, computer software, or a combination thereof. Whether the functions are implemented by using hardware or software depends on particular applications and requirements to a design of a whole system. A person skilled in the art can use different methods to implement the described functions for each particular application, but it should not be considered that the implementation will go beyond the scope of the embodiments disclosed in this application.

It should also be noted that the order of the steps of any disclosed method is not strict because some one or several steps may be rearranged in an actual perform order and/or combined with other one or several steps, and/or divided into a greater number of sub-steps, for example, the S205 step, in which the UL channel is transmitted to the TRP with the performed frequency-selective power adjustment carried out on the basis of the received indication, may be divided into sub-steps in which the UE first performs the frequency-selective power adjustment of the transmitter, and then performs the UL transmission by the power adjusted transmitter. In addition, the S100 and S105 steps can be performed such that first, for an available frequency band, power adjustment values of transmissions of the different scheduled UEs are determined, and then there are determined (for example, from changing the transmit power adjustment values) boundaries of the sub-bands those are signalized on the UE as the sub-bands obtained by dividing.

In all materials of the present application, the reference to an element in the singular does not exclude the presence of a plurality of such elements in an actual implementation of the invention, and, vice versa, the reference to an element in the plural does not exclude the presence of only one such element in an actual implementation of the invention. Any particular value or range of values indicated above is not to be interpreted in a limiting sense, but instead such a particular value or range of values are to be considered as representing a midpoint of a certain greater range, up to approximately 50% at both sides of the specified value or specifically indicated smaller range.

While this disclosure has been shown and described with reference to its various embodiments, those skilled in the art should understand that various changes in form and content can be made without departing from the spirit and scope of this disclosure, as defined by the appended claims and their equivalents. In other words, the above detailed description is based on the specific examples and possible implementations of the present invention, but it should not be interpreted so that only explicitly disclosed implementations are feasible. It is intended that any change or substitution that may be made to the disclosure by an ordinary skill person without introducing a creative and/or technical contribution to the technology should fall within the scope of protection taking into account equivalents, which is provided by the following claims of the present invention.

1. A transmission-reception point (TRP) in a wireless communication system, the TRP comprising:
a transceiver; and
a controller coupled with the transceiver, and configured to:
divide an available frequency band into a plurality of sub-bands, wherein the plurality of sub-bands is associated with an uplink (UL) channel with a frequency-selective transmit power control, identify a transmit power adjustment value for adjusting a power in a sub-band among the plurality of sub-bands,
transmit, to a user equipment (UE), an indication for the plurality of sub-bands, wherein the indication indicates the transmit power adjustment value, and
receive, from the UE, the UL channel with a frequency-selective power adjustment based on the indication.

2. The TRP of claim 1,
wherein the indication is a transmit power control (TPC) command in a downlink control information (DCI) message or a radio resource control (RRC) configuration message, and wherein the UL channel is a physical uplink shared channel (PUSCH).

3. The TRP of claim 1,
wherein the plurality of sub-bands includes more than one adjacent sub-bands with a same width, and
wherein a start and an end of the more than one adjacent sub-bands are indicated by:
an index of a resource element (RE) or resource block (RB); or
an index of the RE or RB and a number of REs or RBs.

4. The TRP of claim 2,
wherein the transmit power adjustment value depends on a number of UEs transmitting simultaneously within the sub-band, and
wherein a range of possible power adjustment values is dynamically expanded by the TPC command indicating additional transmit power adjustment values.

5. A user equipment (UE) in a wireless communication system, the UE comprising:
a transceiver; and
a controller coupled with the transceiver, and configured to:
receive, from a transmission-reception point (TRP), an indication for a plurality of sub-bands obtained by dividing an available frequency band, wherein the plurality of sub-bands is associated with an uplink (UL) channel with a frequency-selective transmit power control and the indication indicates a transmit power adjustment value for adjusting a power in a sub-band among the plurality of sub-bands, and
transmit, to the TRP, the UL channel, with a frequency-selective power adjustment based on the indication.

6. The UE of claim 5,
wherein the indication is a transmit power control (TPC) command in a downlink control information (DCI) message or a radio resource control (RRC) configuration message, and
wherein the UL channel is a physical uplink shared channel (PUSCH).

7. The UE of claim 5,
wherein the plurality of sub-bands includes more than one adjacent sub-bands with a same width, and
wherein a start and an end of the more than one adjacent sub-bands are indicated by:
an index of a resource element (RE) or resource block (RB); or
an index of the RE or RB and a number of REs or RBs.

8. The UE of claim 6,
wherein the transmit power adjustment value depends on a number of UEs transmitting simultaneously with the sub-band, and
wherein a range of possible power adjustment values is dynamically expanded by the TPC command indicating additional transmit power adjustment values.

9. A method performed by a transmission-reception point (TRP) in a wireless communication system, the method comprising:
dividing an available frequency band into a plurality of sub-bands, wherein the plurality of sub-bands is associated with an uplink (UL) channel with a frequency-selective transmit power control;
identifying a transmit power adjustment value for adjusting a power in a sub-band among the plurality of sub-bands;
transmitting, to a user equipment (UE), an indication for the plurality of sub-bands, wherein the indication indicates the transmit power adjustment value; and
receiving, from the UE, the UL channel with a frequency-selective power adjustment based on the indication.

10. The method of claim 9,
wherein the indication is a transmit power control (TPC) command in a downlink control information (DCI) message or a radio resource control (RRC) configuration message, and
wherein the UL channel is a physical uplink shared channel (PUSCH).

11. The method of claim 9,
wherein the plurality of sub-bands includes more than one adjacent sub-bands with a same width, and
wherein a start and an end of the more than one adjacent sub-bands are indicated by:
an index of a resource element (RE) or resource block (RB); or
an index of the RE or RB and a number of REs or RBs.

12. The method of claim 10,
wherein the transmit power adjustment value depends on a number of UEs transmitting simultaneously within the sub-band, and
wherein a range of possible power adjustment values is dynamically expanded by the TPC command indicating additional transmit power adjustment values.

13. A method performed by a user equipment (UE) in a wireless communication system, the method comprising:
receiving, from a transmission-reception point (TRP), an indication for a plurality of sub-bands obtained by dividing an available frequency band, wherein the plurality of sub-bands is associated with an uplink (UL) channel with a frequency-selective transmit power control and the indication indicates a transmit power adjustment value for adjusting a power in a sub-band among the plurality of sub-bands; and
transmitting, to the TRP, the UL channel, with a frequency-selective power adjustment based on the indication.

14. The method of claim 13,
wherein the indication is a transmit power control (TPC) command in a downlink control information (DCI) message or a radio resource control (RRC) configuration message, and
wherein the UL channel is a physical uplink shared channel (PUSCH).

15. The method of claim 13,
wherein the plurality of sub-bands includes more than one adjacent sub-bands with a same width, and
wherein a start and an end of the more than one adjacent sub-bands are indicated by:
an index of a resource element (RE) or resource block (RB); or
an index of the RE or RB and a number of REs or RBs.
